(19) United States
(12) Patent Application Publication
(10) Pub. No.: US 2008/0109763 A1
(43) Pub. Date: May 8, 2008

(54) COMPUTER SYSTEM AND METHOD THEREOF

(75) Inventor: Heun-jin Lee, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/751,884

(22) Filed: May 22, 2007

(30) Foreign Application Priority Data
Nov. 6, 2006 (KR) 2006-108906

(51) Int. Cl. G06F 3/048

(52) U.S. Cl. 715/856

(57) ABSTRACT

A computer system is connected to a display apparatus having a displaying part supporting a multi-view mode, and includes a touch screen panel, a cursor movement selecting part to move a cursor on the touch screen panel onto the displaying part, and a cursor driver to move the cursor on the displaying part according to a stimulus on the touch screen panel upon selection of the cursor movement selecting part.

### CROSS-REFERENCE TO RELATED APPLICATIONS

This application claims the priority of Korean Patent Application No. 2006-0108906, filed on Nov. 6, 2006 in the Korean Intellectual Property Office, the disclosure of which is incorporated herein by reference in its entirety.

### BACKGROUND OF THE INVENTION

1. Field of the Invention

The present general inventive concept relates to a computer system and a control method of the computer system, and more particularly to a computer system capable of supporting a multi-view mode and a control method of the computer system.

2. Description of the Related Art

In a multi-tasking environment where a plurality of tasks are performed simultaneously, one computer main body may be designed to facilitate simultaneous performance of the plurality of tasks by connecting two or more display apparatuses to the one computer main body, which supports the two or more display apparatuses via a multi-view mode providing a dual view. The multi-view mode enables a user to display a plurality of different screens on a plurality of different displaying parts, and is distinguishable from a clone mode that enables a user to display an identical screen on a plurality of different displaying parts.

FIG. 1 is an embodiment of a conventional computer system, in which a first display apparatus 20 and a second display apparatus 30 are connected to one system main body 10. The system main body 10 is connected with a mouse 40 as an input apparatus. The first display apparatus 20 comprises a touch screen panel where an inputting part is a displaying part itself. In the display apparatus comprising the touch screen panel, as illustrated in FIG. 1, a stick or a user's finger is used to interface with the touch screen panel to move an activated window \textcircled{1}. If the activated window \textcircled{1} displayed on the first display apparatus 20 is moved to the second display apparatus 30, a half \textcircled{2} of the activated window \textcircled{1} may be displayed on the first display apparatus 20 and another other half \textcircled{3} of the activated window \textcircled{1} may be displayed on the second display apparatus 30. When the user's finger or the stick reaches a border of the first display apparatus 20, the activated window \textcircled{1} may not be completely moved to the second display apparatus 30 because the second display apparatus 30 does not comprise the touch screen panel. That is, because a cursor is not capable of movement according to a user's desire, conventional computer systems are limited in that an additional input apparatus should be provided, such as a mouse.

The limitation also occurs in conventional computer systems that employ a small-sized portable computer system comprising the touch screen panel, which have been recently developed and are commonly used for presentations or other purposes. The user may realize the dual-view mode by connecting other display apparatus to the portable computer system, but is unable to move the cursor from the touch screen panel to the other display apparatus, thus limiting utilization of the portable computer system.

### SUMMARY OF THE INVENTION

The present general inventive concept provides a computer system that enables a cursor on a touch screen panel to be easily moved to an outer display apparatus, and a method of controlling the computer system.

The present general inventive concept also provides a computer system where a touch screen panel may be used as a touch pad when the computer system is operated in a multi-view mode, and a method of controlling the computer system.

Additional aspects of the present general inventive concept will be set forth in part in the description which follows and, in part, will be obvious from the description, or may be learned by practice of the present general inventive concept.

The foregoing and/or other aspects and utilities of the present general inventive concept may be achieved by providing a computer system connected to a display apparatus having a displaying part to support a multi-view mode, the computer system comprising a touch screen panel, a cursor movement selecting part to move a cursor on the touch screen panel onto the displaying part, and a cursor driver to move the cursor on the displaying part according to a stimulus on the touch screen panel.

The cursor driver may move the cursor on the displaying part according to one of a first mode where movement of the cursor on the displaying part corresponds to the stimulus on the touch screen panel, and the cursor starts from a position on the displaying part corresponding to a first stimulus point on the touch screen panel, and a second mode where movement of the cursor on the displaying part corresponds to the stimulus on the touch screen panel, and the cursor starts from a position on the displaying part corresponding to a present position of a window on the displaying part.

The computer system may comprise a user interface (UI) generating part to generate a mode selecting window to select one of the first mode and the second mode.

If the first mode is selected, the cursor driver may calculate the position of the cursor on the displaying part to correspond to the stimulus point on the touch screen panel based on a resolution of the touch screen panel and a resolution of the displaying part.

The stimulus point on the touch screen panel and the cursor on the displaying part may be positioned on a predetermined two dimensional coordinate system, and if the resolution of the touch screen panel is A1*B1, the resolution of the displaying part is C1*D1, an origin (0, 0) of the displaying part corresponds to (E, F) on the two dimensional coordinate system, the coordinate values of the stimulus point on the touch screen panel are (x, y), and the coordinate values (a, b) of the cursor on the displaying part may be calculated by an equation (1) as follows:

(a, b)=((x*C1/A1)+E, (y*D1/B1)+F) (1)

If the first mode is selected, a cursor alarm icon may be displayed on the touch screen panel to correspond to the position of the cursor on the displaying part.

The mode selecting window may comprise a default icon, and a default mode, wherein one of the first mode and the second mode may be set as the default mode.

According to an aspect of the present general inventive concept, the default mode is the first mode.

If a predetermined activated window formed on the touch screen panel is selected, and if the cursor movement selecting part is selected, then the activated window is moved onto the displaying part, and if a predetermined activated window formed on the displaying part is selected, and if the cursor movement selecting part is selected, then the activated window may be moved onto the touch screen panel.

The cursor movement selecting part may comprise a toggle button cursor movement selecting part.

The foregoing and/or other aspects and utilities of the present general inventive concept may further be achieved by providing a portable computer system to support a multi-view mode, the portable computer system comprising a touch screen panel, a pad transforming button to transform the touch screen panel into a touch pad to control an image displayed on a display part of a display apparatus to enable the display apparatus to be connected to the portable computer system and operated as the multi-view mode, and a cursor driver may move a cursor on the displaying part according to a stimulus on the touch screen panel.

The cursor driver may move the cursor on the displaying part according to one of a first mode where the cursor on the displaying part moves according to the stimulus on the touch screen panel and starts from a position on the displaying part corresponding to a first stimulus point on the touch screen panel and a second mode where the cursor on the displaying part may move according to the stimulus on the touch screen panel and may start from a present position on the displaying part.

The portable computer system may further comprise a user interface (UI) generating part to generate a mode selecting window to select one of the first mode and the second mode.

If the first mode is selected, the cursor driver calculates the position of the cursor on the displaying part to correspond to the stimulus point on the touch screen panel based on a resolution of the touch screen panel and the resolution of the displaying part.

If a predetermined activated window formed on the touch screen panel is selected and if the pad transforming button is selected, the activated window is moved onto the displaying part, and if a predetermined activated window formed on the displaying part is selected and if the pad transforming button is selected, the activated window is moved onto the touch screen panel.

The pad transforming button may comprise a toggle button.

The foregoing and/or other aspects and utilities of the present general inventive concept may further be achieved by providing a control method of a computer system connected to a display apparatus having a displaying part and supporting a multi-view mode, the control method comprising providing a cursor movement selecting part to move a cursor on a touch screen panel onto the displaying part, and moving the cursor on the displaying part corresponding to a stimulus on the touch screen panel when receiving a control signal.

Moving the cursor may comprise moving the cursor on the displaying part to a position on the displaying part to correspond to a first stimulus point on the touch screen panel.

Moving the cursor may comprise calculating the position of the cursor on the displaying part to correspond to the moved stimulus point on the touch screen panel based on a resolution of the touch screen panel and a resolution of the displaying part, and moving the cursor on the displaying part to the calculated position.

The stimulus point on the touch screen panel and the cursor on the displaying part may be positioned on a predetermined two dimensional coordinate system, and if the resolution of the touch screen panel is A1*B1, the resolution of the displaying part is C1*D1, an origin (0, 0) of the displaying part corresponds to (E, F) on the two dimensional coordinate system, and the coordinate values of the stimulus point on the touch screen panel are (x, y), then the coordinate values (a, b) of the cursor on the displaying part is calculated by an equation (1) as follows:

(a, b)=((x*C1/A1)+E, (y*D1/B1)+F) (1).

The foregoing and/or other aspects and utilities of the present general inventive concept may further be achieved by providing a computer system comprising a touch screen pad, and a cursor movement selecting part to copy an image of the touch screen pad to an external display unit and to move the image to the external display unit according to a touching state of the touch screen pad.

The cursor movement selecting part may be spaced apart from the touch screen pad in a distance when a user hand holds the computer system, a finger of the user hand reaches the cursor movement selecting part.

The cursor movement selecting part may comprise a button to display a first mode and a second mode on the touch screen pad and to copy the image and to move the image on the external display unit respectively.

The image may be a cursor.

The image may be displayed on a first position of the touch screen pad, and the cursor movement selecting part may copy the image to a second position of the external display unit corresponding to the first position with respect to an axis.

The touch screen pad may be a touch pad, and the external display unit may not be a touch pad.

The computer system may comprise a user generating part to display a mode image on the touch screen pad such that the cursor movement selecting part moves the image displayed on the external displaying unit according to selection of the displayed mode image.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic view of a conventional computer system.

FIG. 2 is a schematic view of a computer system according to an embodiment of the present general inventive concept.

FIG. 3 is a control block diagram of the computer system of FIG. 2.

FIG. 4 illustrates a mode selecting window of the computer system of FIGS. 2 and 3.

FIG. 5A and FIG. 5B are schematic views to illustrate a first mode of the computer system of FIGS. 2 and 3.

FIG. 6 is a schematic view to illustrate a second mode of the computer system of FIGS. 2 and 3.

FIG. 7 illustrates a movement of an activated window of the computer system of FIGS. 2 and 3.

FIG. 8 is a control flow diagram to illustrate a control method of a computer system according to an embodiment of the present general inventive concept.

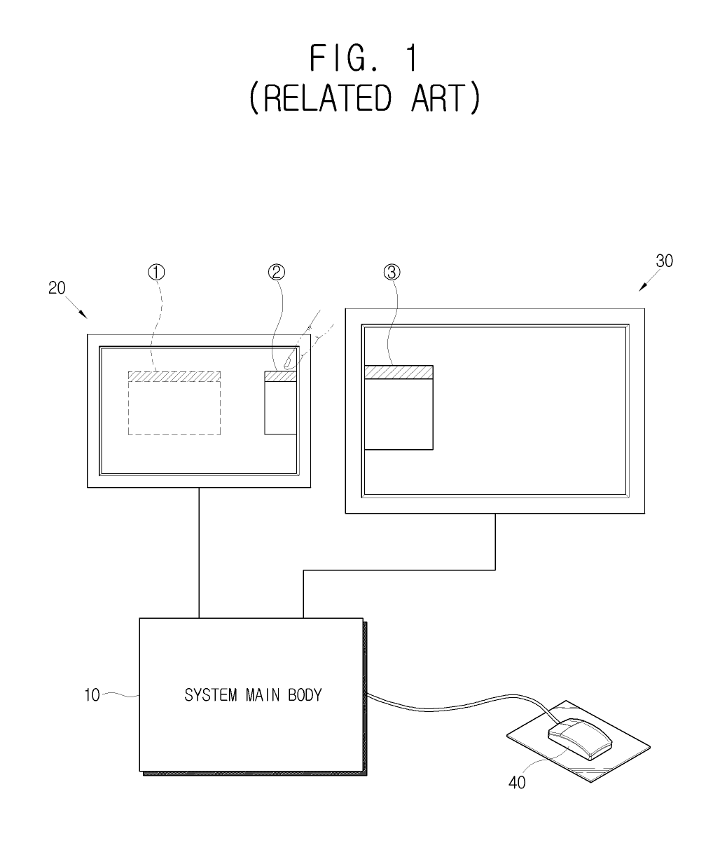

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

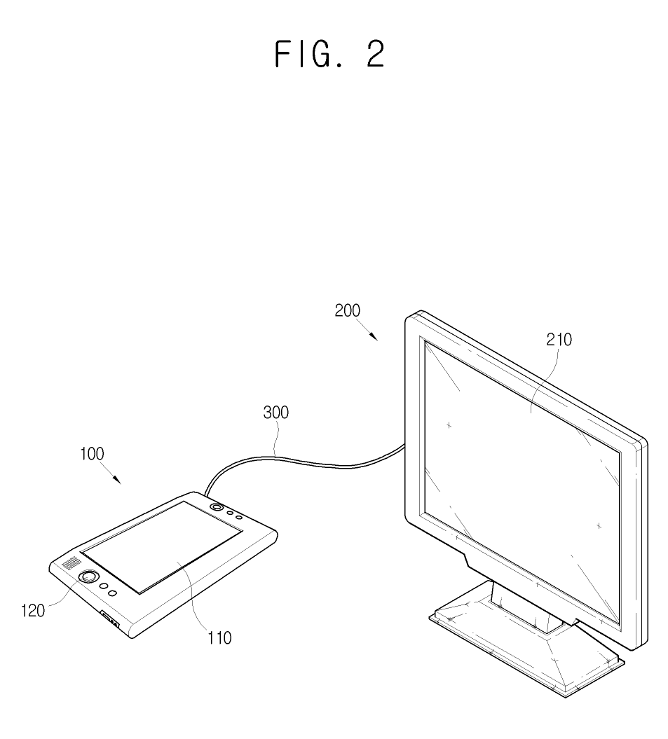

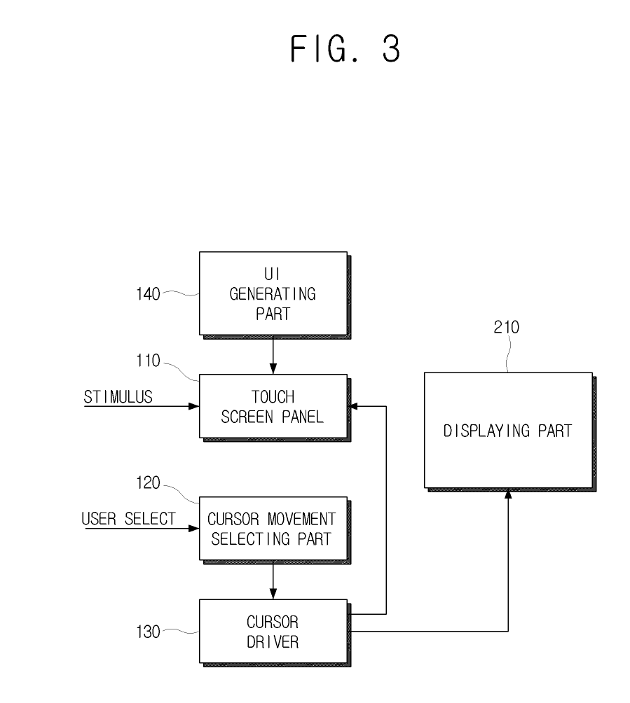

FIG. 2 is a schematic view of a computer system 100 according to an embodiment of the present general inventive concept. FIG. 3 is a control block diagram of the computer system 100 according to the embodiment of the present general inventive concept.

As illustrated in FIG. 2, the computer system 100 according to this embodiment is connected with a display apparatus 200 by using a predetermined cable 300. The computer system 100 and the display apparatus 200 may be connected wirelessly therebetween without the cable 300. In this case, the computer system 100 and the display apparatus 200 may comprise a wireless transceiver to enable wireless communication. Also, while the computer system 100 of this embodiment does not comprise the display apparatus 200, the present general inventive concept is not limited to this embodiment, and the computer system may be defined as an entire system which comprises the display apparatus 200.

The computer system 100 according to this embodiment is a small-sized portable computer which has a displaying part integrated within a main body part and which may be carried by a user without difficulty. The main body may not include elements to perform functions of the portable computer. However, the computer system according to the present general inventive concept is not necessarily limited to the small-sized portable computer, but may include large-sized computers, such as desktop computers that are not necessarily portable. While the computer system 100 may include an inputting apparatus, such as a keyboard, a mouse and the like, the computer system 100 comprises a touch screen panel 110, which is stimulated by a part of a human body, especially a hand and/or finger, or by a predetermined pointing stick, such as but not limited to a pen, pencil and/or stylus. The computer system 100 further comprises a cursor movement selecting part 120 to move a cursor according to a user's selection, a cursor driver 130, and a UI generating part 140 providing a user interface.

The display apparatus 200 comprises a displaying part 210 to display an image. The display apparatus 200 is connected to the computer system 110 and displays the image by control of the computer system 100. A plurality of display apparatuses 200 may be connected to the computer system 100. Since the displaying part 210 does not comprise a touch panel like the touch screen panel 110 of the computer system 100, a screen of the displaying part 210 is not capable of use as the input apparatus.

As illustrated in FIG. 2, the cursor movement selecting part 120 is provided near the touch screen panel 110, and may be in a position where the cursor movement selecting part 120 may be easily manipulated by the hand that is holding the computer system 100, thereby enabling the user to carry and operate the computer system 100 with one hand. That is, when a user holds the computer system 100, the cursor movement selecting part 120 may be disposed within a distance to be reachable by a finger of the user hand. The cursor movement selecting part 120 moves the cursor on the touch screen panel 110 onto the displaying part 210. That is, if the cursor movement selecting part 120 is selected, the touch screen panel 110 is transformed into a touch pad to control an image displayed on the displaying part 210, such as an activated window. Therefore, the cursor movement selecting part 120 may be considered as a pad transforming button to transform the touch screen panel 110 into the touch pad. After the cursor movement selecting part 120 is selected, the stimulus on the touch screen panel 110 may open, move, or close the activated window of the displaying part 210. If the activated window extends across both of the touch screen panel 110 and the displaying part 210 during movement of the activated window, the cursor may be easily moved onto the displaying part 210 by selecting the cursor movement selecting part 120, thus controlling the activated window on the displaying part 210.

The cursor movement selecting part 120 may be provided as a toggle button, an additional touch pad, or other cursor controlling device capable of controlling cursor directional movement such as, but not limited to a joy stick device. If the cursor movement selecting part 120 is provided as the toggle button, it enables movement of the cursor onto the displaying part 210 when the toggle button is pushed or being pushed, thus performing as an inputting part of the displaying part 210. When the toggle button is not pushed, the cursor movement selecting part 120 performs as the inputting part of the touch screen panel 110. That is, the cursor moves when a pressure applied onto the button is maintained at a predetermined pressure, and the cursor returns to its original state and/or position if the pressure applied onto the button is removed. Alternatively, instead of using the cursor movement selecting part 120, the cursor may be set to be moved onto the displaying part 210 when the touch screen panel 110 is stimulated by a predetermined pattern, such as a predetermined finger swipe or a predetermined number of taps on the touch screen panel. For example, the cursor could be moved by a predetermined finger swipe such as, but not limited to whereby the user's finger moves in an “S” pattern, and/or the cursor could be moved by a predetermined number of taps such as, but not limited to whereby a user's finger taps the control screen panel 110 three times.

If the cursor movement selecting part 120 is selected, the cursor driver 130 moves the cursor on the displaying part 210 according to the stimulus on the touch screen panel 110. The cursor driver 130 according to this embodiment moves the cursor on the displaying part 210 according to a first mode or a second mode.

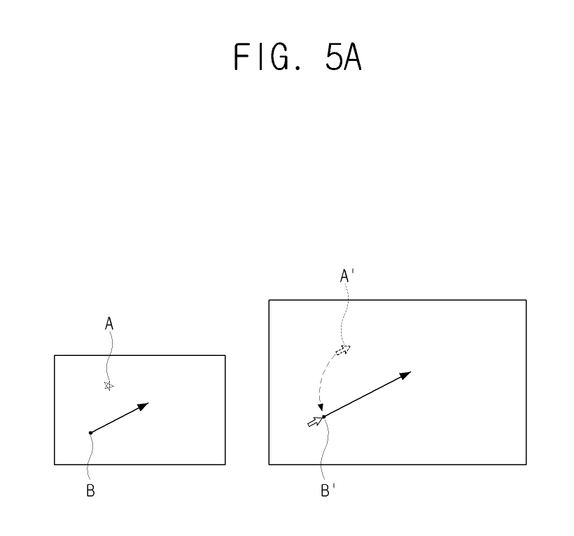

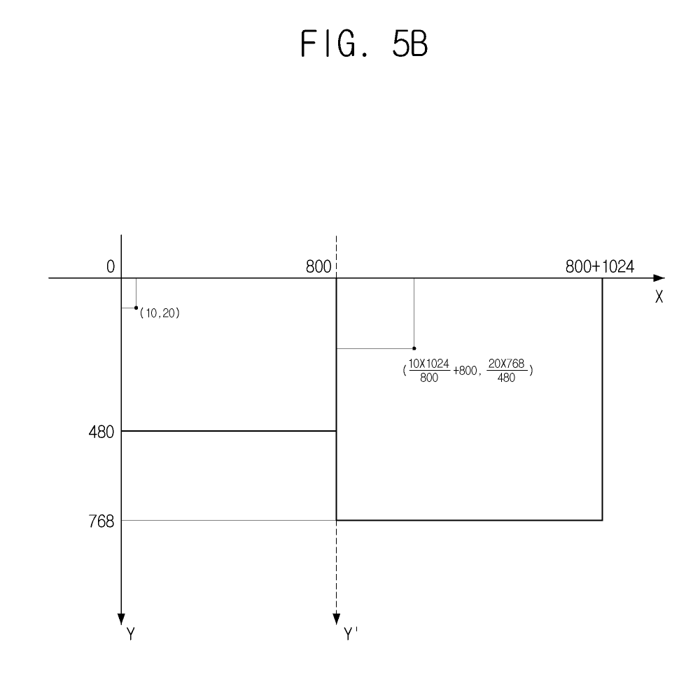

The first mode allows an image and/or the cursor to be moved or duplicated from the touch screen panel 110 to the displaying part 210 and/or to be displayed on the displaying part 210 corresponding to and in direct proportion to the stimulus point on the touch screen panel 110. If the size of the touch screen panel 110 is the same as the size the displaying part 210, the cursor will move at a position on the displaying part 210 by the same amount of and in exact proportion to the distance of the stimulated position on the touch screen panel 110. If the size of the touch screen panel 110 is different from that of the displaying part 210, the cursor can be programmed to move on the displaying part 210 by considering a resolutions difference and in a larger proportion to the distance of the stimulated position on the touch screen panel 110. For example, if one point on the touch screen panel 110 corresponds to points on the displaying part 210, then movement of the stimuli on the touch screen panel 110 for a first distance could be programmed to result in a movement of the cursor for twice the distance of the first distance on the displaying part 210. If the first mode is selected and the stimulus is applied onto the touch screen panel 110 for the first time, the cursor on the displaying part 210 moves to a position which corresponds to the first stimulus point on the touch screen panel 110. FIG. 5A is a schematic view describing movement of the cursor on the displaying part 210 according to the first mode. If there is a stimulus on the touch screen panel 110, the cursor which was located at a first position A′ on the displaying part 210 moves (dotted line) to a second position B′ corresponding to the first stimulus point B on the touch screen panel 110 and then continues to move according to a subsequent stimulus. It is possible but not necessary that, if the first mode is selected, a cursor alarm icon is displayed at a position A on the touch screen panel 110 corresponding to the first position A′ so that the user may be informed where the cursor is currently located on the displaying part 210. Also, the cursor alarm icon may be displayed on the displaying part 210 to help easily finding the position of the cursor if the cursor is moved from the touch screen panel 110 to the displaying part 210 by the cursor movement selecting part 120.

FIG. 5B illustrates a coordinate system to explain a method for the cursor driver 130 to move the cursor according to the first mode. Positions of cursors on the touch screen panel 110 and on the displaying part 210 are represented in a two dimensional coordinate system (X-Y). If the first mode is selected, all points on the touch screen panel 110 and on the displaying part 210 are considered to be located in the one two dimensional coordinate system. Also, if the first mode is selected, the cursor driver 130 calculates the position of the cursor on the displaying part 210, which corresponds to the stimulus point on the touch screen panel 110, based on the resolution of the touch screen panel 110 and the resolution of the displaying part 210.

For example, it is supposed that the resolution of the touch screen panel 110 is 800*480, the resolution of the displaying part 210 is 1024*768, and the displaying part 210 is located at the right side of the touch screen panel 110. In this embodiment, that the displaying part 210 is located at the right side of the touch screen panel 110 does not mean that the displaying part 210 is physically located at the right side of the touch screen panel 110, but means that the displaying part 210 is expanded to the right side of the touch screen panel 110 in the multi-view mode supported by the computer main body. Firstly, in order to correspond a point on the touch screen panel 110 to a point on the displaying part 210, a position of the point on the displaying part 210, which corresponds to the point (10, 20) on the touch screen panel 110 as illustrated in FIG. 5B is calculated in consideration of difference in the resolutions between the touch screen panel 110 and the displaying part 210. The point (10, 20) on the touch screen panel 110 corresponds to a point (10*1024/800, 20*768/480) on a coordinate system X-Y′ if only the displaying part 210 is considered. Then, if the above value is added to by a value by which the displaying part 210 is shifted from the touch screen panel 110, that is, a coordinate value which is based on a relative position of the displaying part 210 with regard to the touch screen panel 110, the point (10, 20) on the touch screen panel 110 finally corresponds to (10*1024/800+800, 20*768/480) on the displaying part 210. The cursor driver 130 moves the cursor on the displaying part 210 through the above calculations.

Therefore, if generalizing the position of the displaying part 210, the origin (0, 0) of the displaying part 210 corresponds to a position on the two dimensional coordinate system (x, y¹). Also, if the resolution of the touch screen panel 110 is A1×B1, the resolution of the displaying part 210 is C1×D1, and the coordinate values of stimulus point on the touch screen panel 110 is (x, y), then the coordinate values (a, b) of the cursor on the displaying panel 210 is as follows:

(a, b)=((x*C1/A1)+E, (y*D1/B1)+F) (1)

That is, as described in the above embodiment, if the displaying part 210 is positioned at the right side of the touch screen panel 110, E is equal to 800 and F is equal to 0 because the origin (0, 0) of the displaying part 210 corresponds (800, 0) on the coordinates.

If the displaying part 210 is positioned at the left side of the touch screen panel 110, E will be a negative number. The position of the cursor on the displaying part 210 can be calculated by adjusting the values of E and F according to the position of the displaying part 210 with regard to the touch screen panel 110.

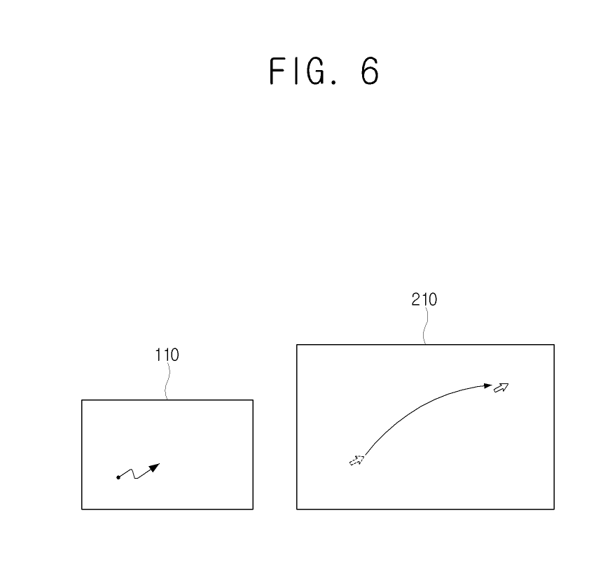

The second mode allows an image and/or the cursor to start moving on the displaying part 210 by the touch pad or the mouse according to a set moving speed. That is, the cursor movement corresponds to the stimulus on the touch screen panel 110. FIG. 6 is a schematic view to explain the second mode of the computer system according to this embodiment of the present general inventive concept. As illustrated in FIG. 6, the movement of the cursor on the displaying part 210 is not directly proportional to the stimulus formed on the touch screen panel 110 because the cursor at the second mode does not move according to absolute positions in the two dimensional coordinate system unlike at the first mode.

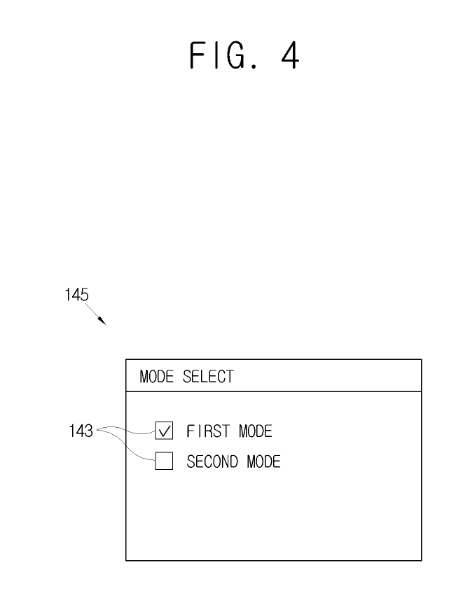

The UI generating part 140 generates and displays a mode selecting window to allow the user to select the first mode or the second mode. FIG. 4 illustrates the mode selecting window 145 of the computer system according to the present general inventive concept. If the cursor movement selecting part 120 is selected, the mode selecting window 145 is displayed on the touch screen panel 110 or the displaying part 210. The mode selecting window 145 comprises a menu by which the first mode or the second mode can be selected. The user may select the first mode or the second mode using the menu. Also, the mode selecting window 145 comprises a default icon 143 at a side of each mode menu to set one of the first mode and the second mode as a default mode. If one of modes is set as the default mode by the default icon 143, the mode selecting window 145 may not be displayed if the cursor movement selecting part 120 is selected, and the cursor on the displaying part 210 may be moved according to the set mode. The user may cancel or change the default mode through the mode selecting window 145.

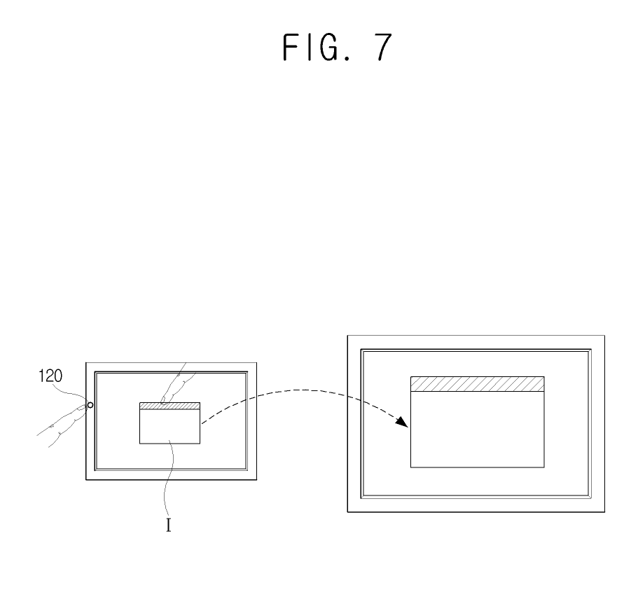

FIG. 7 illustrates a movement of an activated window of a computer system according to the present general inventive concept wherein the computer system provides a simple and convenient method to move the activated window in order to increase convenience and thereby increase efficiency so that if the activated window I displayed on the touch screen panel 110 is required to be moved onto the displaying part 210, the activated window I is dragged, the cursor movement selecting part 120 is selected, and the cursor is displayed on the displaying part 210 to be moved thereon, as illustrated in FIG. 7. If the user selects the activated window I to be moved, and if the user selects the cursor movement selecting part 120 without any other process, the activated window I on the touch screen panel 110 is moved onto the displaying part 210. Likewise, the same process is applied when the activated window on the displaying part 210 is moved onto the touch screen panel 110. Selecting the activated window I is generally executed by selecting a bar, where a name of the activated window I is displayed, at an upper side of the activated window 1.

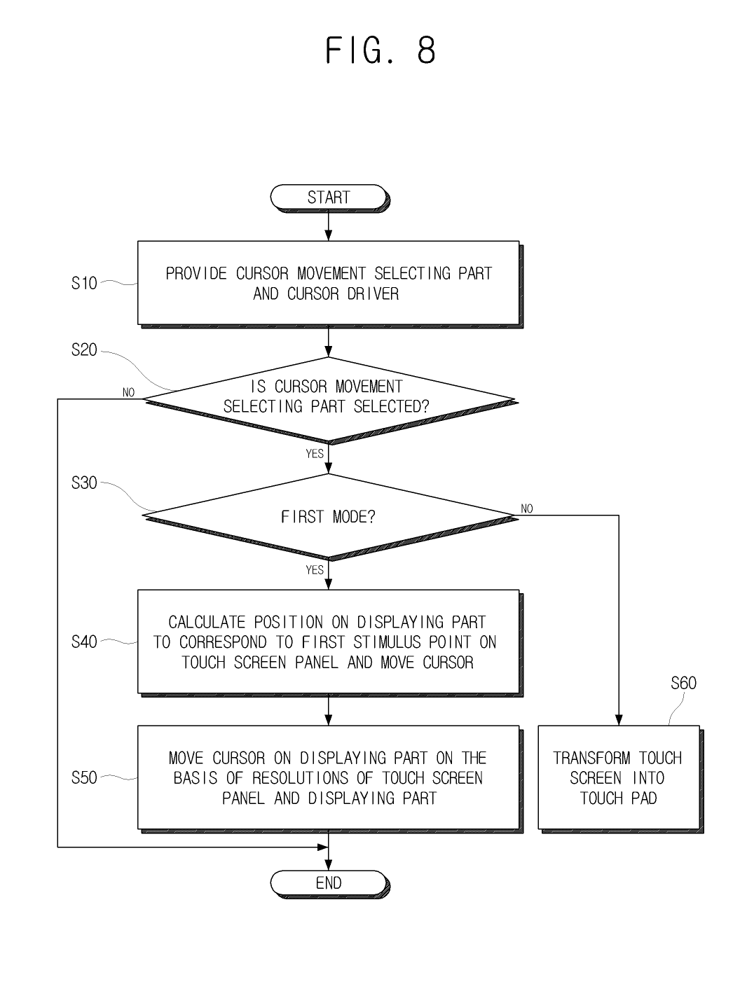

FIG. 8 is a control flow diagram to illustrate a control method of a computer system according to an embodiment of the present general inventive concept.

Hereinafter, a method to control the cursor on the displaying part 210 is described with reference to FIGS. 2-8.

The cursor movement selecting part 120 and the cursor driver 130 which move the cursor of the displaying part 210 according to the stimulus on the touch screen panel 110 when the cursor movement selecting part 120 is selected are provided at S10.

If the default mode has been set when the cursor movement selecting part 120 is selected by the user at S20, the cursor is moved according to the set default mode. However, if the default mode has not been set, the user selects one of the first mode and the second mode.

If the default mode is the first mode or the first mode is selected by the user at S30, the cursor driver 130 calculates the position of the cursor on the displaying part 210 to correspond to the first stimulus point on the touch screen panel 110 and moves the cursor on the displaying part 210 at S40.

The position of the cursor on the displaying part 210 is moved on the same coordinate system corresponding to the resolutions of the touch screen panel 110 and the displaying part 210. That is, the cursor driver 130 calculates the position of the cursor on the displaying part 210 to correspond to the moved stimulus point on the touch screen panel 110 on the basis of the resolution of the touch screen panel 110 and the resolution of the displaying part 210 and moves the cursor on the coordinate system according to the calculation at S50.

If the second mode is selected, the touch screen panel 110 is transformed into the touch pad and performs as the inputting part to move the cursor on the displaying part 120 at S60.

In the computer system which supports the multi-view mode comprises the touch screen panel 110, the present general inventive concept is used to easily move the cursor on the touch screen panel 110 onto another displaying part 210, thus expanding the utility of the touch screen panel 110, which performs as the inputting part.

As described above, according to the present general inventive concept, the computer system where the cursor on the touch screen panel may be easily moved to an outer display apparatus and the control method of the computer system may be provided.

Also, according to the present general inventive concept, the computer system where the touch screen panel may be used as the touch pad when the computer system is operated in the multi-view mode and the control method of the computer system may be provided.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A computer system connected to a display apparatus having a displaying part to support a multi-view mode, the computer system comprising:
a touch screen panel;
a cursor movement selecting part to move a cursor on the touch screen panel onto the displaying part; and
a cursor driver to move the cursor on the displaying part according to a stimulus on the touch screen panel.

2. The computer system according to claim 1, wherein the cursor driver moves the cursor on the displaying part according to one of a first mode where movement of the cursor on the displaying part corresponds to the stimulus on the touch screen panel, and the cursor starts from a position on the displaying part corresponding to a first stimulus point on the touch screen panel, and a second mode where the movement of the cursor on the displaying part corresponds to the stimulus on the touch screen panel, and the cursor starts from a position on the displaying part corresponding to a present position of a window on the display part.

3. The computer system according to claim 2 further comprising:
a user interface (UI) generating part to generate a mode selecting window to select one of the first mode and the second mode.

4. The computer system according to claim 3, wherein the first mode is selected, and the cursor driver calculates the position of the cursor on the displaying part to correspond to the stimulus point on the touch screen panel based on a resolution of the touch screen panel and a resolution of the displaying part.

5. The computer system according to claim 4, wherein the stimulus point on the touch screen panel and the cursor on the displaying part are positioned on a predetermined two dimensional coordinate system,
the resolution of the touch screen panel is A1*B1, the resolution of the displaying part is C1*D1, an origin (0, 0) of the displaying part corresponds to (E, F) on the two dimensional coordinate system, the coordinate values of the stimulus point on the touch screen panel are (x, y), and the coordinate values (a, b) of the cursor on the displaying part is calculated by an equation (1) as follows:
(a, b)=((x*C1/A1)+E, (y*D1/B1)+F) (1)

6. The computer system according to claim 5, wherein the first mode is selected, and a cursor alarm icon is displayed on the touch screen panel to correspond to the position of the cursor on the displaying part.

7. The computer system according to claim 3, the mode selecting window comprising:
a default icon; and
a default mode,
wherein one of the first mode and the second mode is set as the default mode.

8. The computer system according to claim 7, wherein the default mode is the first mode.

9. The computer system according to claim 1, wherein a predetermined activated window formed on the touch screen panel is selected, the cursor movement selecting part is selected, and the activated window is moved onto the displaying part, and
a predetermined activated window is formed on the displaying part is selected, the cursor movement selecting part is selected, and the activated window is moved onto the touch screen panel.

10. The computer system according to claim 1, further comprising:
a toggle button cursor movement selecting part.

11. A portable computer system to support a multi-view mode, the portable computer system comprising:
a touch screen panel;
a pad transforming button to transform the touch screen panel into a touch pad to control an image displayed on a display part of a display apparatus to enable the display apparatus to be connected to the portable computer system and operated as the multi-view mode; and
a cursor driver to move a cursor on the displaying part according to a stimulus on the touch screen panel.

12. The portable computer system according to claim 11, wherein the cursor driver moves the cursor on the displaying part according to one of a first mode where the cursor on the displaying part moves according to the stimulus on the touch screen panel and starts from a position on the displaying part corresponding to a first stimulus point on the touch screen panel, and a second mode where the cursor on the displaying part moves according to the stimulus on the touch screen panel and starts from a present position on the displaying part.

13. The portable computer system according to claim 12 further comprising:
a user interface (UI) generating part to generate a mode selecting window to select one of the first mode and the second mode.

14. The portable computer system according to claim 13, wherein the first mode is selected, and the cursor driver calculates the position of the cursor on the displaying part to correspond to the stimulus point on the touch screen panel based on a resolution of the touch screen panel and a resolution of the displaying part.

15. The portable computer system according to claim 11, wherein a predetermined activated window formed on the touch screen panel is selected, the pad transforming button is selected, and the activated window is moved onto the displaying part, and
a predetermined activated window formed on the displaying part is selected, the pad transforming button is selected, and the activated window is moved onto the touch screen panel.

16. The portable computer system according to claim 11, wherein the pad transforming button comprises a toggle button.

17. A control method of a computer system connected to a display apparatus having a displaying part and supporting a multi-view mode, the control method comprising:
providing a cursor movement selecting part to move a cursor on a touch screen panel onto the displaying part; and
moving the cursor on the displaying part corresponding to a stimulus on the touch screen panel when receiving a control signal.

18. The control method of the computer system according to claim 17, wherein moving the cursor comprises:
moving the cursor on the displaying part to a position on the displaying part to correspond to a first stimulus point on the touch screen panel.

19. The control method of the computer system according to claim 18, wherein moving the cursor comprises:
calculating the position of the cursor on the displaying part to correspond to the moved stimulus point on the touch screen panel based on a resolution of the touch screen panel and a resolution of the displaying part, and moving the cursor on the displaying part to the calculated position.

20. The control method of a computer system according to claim 19, wherein the stimulus point on the touch screen panel and the cursor on the displaying part are positioned on a predetermined two dimensional coordinate system, and
the resolution of the touch screen panel is A1*B1, the resolution of the displaying part is C1*D1, an origin (0, 0) of the displaying part corresponds to (E, F) on the two dimensional coordinate system, and the coordinate values of the stimulus point on the touch screen panel are (x, y), and the coordinate values (a, b) of the cursor on the displaying part is calculated by an equation (1) as follows:
(a, b)=((x*C1/A1)+E, (y*D1/B1)+F) (1)

21. A computer system comprising:
a touch screen pad; and
a cursor movement selecting part to copy an image of the touch screen pad to an external display unit and to move the image to the external display unit according to a touching state of the touch screen pad.

22. The computer system of claim 21, wherein the cursor movement selecting part is spaced apart from the touch screen pad in a distance when a user hand holds the computer system, a finger of the user hand reaches the cursor movement selecting part.

23. The computer system of claim 21, wherein the cursor movement selecting part comprises:
a button to display a first mode and a second mode on the touch screen pad and to copy the image and to move the image on the external display unit respectively.

24. The computer system of claim 21, wherein the image is a cursor.

25. The computer system of claim 21, wherein the image is displayed on a first position of the touch screen pad, and the cursor movement selecting part copies the image to a second position of the external display unit corresponding to the first position with respect to an axis.

26. The computer system of claim 21, further comprising:
a user generating part to display a mode image on the touch screen pad such that the cursor movement selecting part moves the image displayed on the external displaying unit according to selection of the displayed mode image.
